(19) United States
(12) Patent Application Publication
(10) Pub. No.: US 2003/0138622 A1
(43) Pub. Date: Jul. 24, 2003

(54) Polyolefin foam/film composite structure and method for making same

(76) Inventor: N. S. Ramesh, Grapevine, TX (US)

Correspondence Address: Sealed Air Corporation, Law Department, 100 Rogers Bridge Road, Bldg. A, P.O. Box 464, Duncan, SC, 29334, US

(21) Appl. No.: 10/348,837

(22) Filed: Jan. 22, 2003

Related U.S. Application Data
(62) Division of application No. 09/880,459, filed on Jun. 13, 2001, now abandoned.

(51) Int. Cl. B32B 3/26; B32B 9/00; B32B 27/00

(52) U.S. Cl. 428/319.7; 428/304.4; 428/318.4; 428/319.3

(57) ABSTRACT

A composite structure includes, a polyolefin foam in adherence with a film. The film comprises ethylene/styrene interpolymer, homogeneous ethylene/alpha-olefin copolymer, and various blends of such materials. Advantageously, the film in adherence with the foam sheet results in a coefficient of friction ranging from about 0.5 to about 2.0 as measured at the upper surface of the film.

### BACKGROUND OF THE INVENTION

The present invention relates generally to polyolefin foams and, more particularly, to extruded polyethylene foam sheets having an elastomer-containing film adhered thereto.

Polyolefin foams, particularly polyethylene foams, and methods for manufacturing such foams are well known in the art. See, e.g., U.S. Pat. Nos. 5,348,984 (Lee), 5,462,974 (Lee), and 5,667,728 (Lee), the disclosures of which are incorporated herein by reference thereto. One of the most common polyethylenes used is low density polyethylene (LDPE).

Polyethylene (PE) possesses a number of characteristic physical and chemical properties when used to produce a foamed sheet. Of present interest is the coefficient of friction (COF) of the surface of PE foam sheet, which generally is relatively low. While this property is generally desirable for certain applications, e.g., wave-boards (also known as bodyboards), kick-boards, and other watersport articles, in other applications, the low COF of PE foam is disadvantageous. A particular such application wherein a higher COF would be desired is the use of PE foam for a tool box liner, i.e., a cushion upon which tools may be placed in a tool box to protect both the tools and the tool box, and also to decrease the noise generated when the tool box is moved or otherwise handled. Tool boxes often have individual drawers that are pulled out to provide access to a desired tool. Such movement places a lateral force on the tools at the point at which the tools rest on the surface of the base of the drawer. Absent sufficient frictional force between the tools and the drawer, the tools have a tendency to slide relative to the drawer surface towards the rear of the drawer, thereby accumulating in a disorderly jumble at the rear of the drawer. As can be appreciated, this situation makes it more difficult to locate the intended tool than if the tools were neatly arrayed on the base of the drawer. Similar tool movement can also occur during movement or other handling of the tool box.

Notwithstanding PE foam's inherently low COF, it is advantageously used as a liner that is disposed at the base of drawers or other flat surfaces within tool boxes, due to its excellent cushioning and sound-dampening capabilities. Such properties provide both noise-reduction and protection to the tools and tool box during movement of the tool box and its component parts, e.g., opening of drawers. The cushioning provided by PE foam tool box liners also protects the tools and tool box as tool users often return their tools to the box during a project by tossing the tools into the tool box. In addition, the closed-cell construction of PE foam is such that dirt, oil, etc. is prevented from penetrating the PE foam liner, and thereby keeps the box and its components from accumulating dirt and oil. Instead, dirty liners are periodically replaced, which is much more convenient than cleaning the box.

However, due to the inherently low COF of PE foam, conventional PE foam leaves much to be desired as a tool box liner, since it allows tools to move around within the tool box as described above instead of holding the tools in place during movement of the box or its component drawers.

Another application in which a higher COF would be desired for PE foam is the use of a non-skid PE foam placed on airplane wings to facilitate servicing of the aircraft. This would protect the wing surface of the aircraft as maintenance personnel walk thereon while minimizing the risk to the maintenance workers of slipping and falling from the wing.

Other applications for PE foam wherein a higher COF would be desirable include the use of PE foam for the packaging of articles to protect them during shipment. For many articles, e.g., interior and exterior automotive parts, a higher COF would help to keep the foam properly in place in relation to the packaged article by increasing the cling or grip between the foam and the article.

Accordingly, a need exists in the art for a material that provides the same cushioning and sound-dampening performance as conventional PE foam, but which has a higher COF in order to allow objects disposed on the material to remain in place during movement or vibration.

### SUMMARY OF THE INVENTION

That need is met by the present invention, which provides a composite structure comprising:

a. a foam sheet comprising polyolefin; and

b. a film having an upper surface and a lower surface in adherence with a surface of the foam sheet, the film comprising at least one member selected from

(1) ethylene/styrene interpolymer,

(2) a blend of ethylene/styrene interpolymer and a thermoplastic elastomer,

(3) a blend of ethylene/styrene interpolymer, a thermoplastic elastomer, and polyethylene homopolymer or copolymer,

(4) homogeneous ethylene/alpha-olefin copolymer having a density in the range of 0.87-0.91 g/cc, or

(5) a blend of the homogeneous ethylene/alpha-olefin copolymer and a thermoplastic elastomer,

whereby, the film in adherence with the foam sheet results in a coefficient of friction ranging from about 0.5 to about 2.0 as measured at the upper surface of the film.

Another aspect of the invention is a method for making a composite structure, comprising:

a. providing a foam sheet comprising polyolefin; and

b. adhering a film having an upper surface and a lower surface to a surface of the foam sheet, the lower surface of the film being in adherence with the foam sheet, the film comprising at least one member selected from

(1) ethylene/styrene interpolymer,

(2) a blend of ethylene/styrene interpolymer and a thermoplastic elastomer,

(3) a blend of ethylene/styrene interpolymer, a thermoplastic elastomer, and polyethylene homopolymer or copolymer,

(4) homogeneous ethylene/alpha-olefin copolymer having a density in the range of 0.87-0.91 g/cc, or

(5) a blend of the ethylene/alpha-olefin copolymer and a thermoplastic elastomer,

whereby, the film in adherence with the foam sheet results in a coefficient of friction ranging from about 0.5 to about 2.0 as measured at the upper surface of the film.

The COF range of 0.5 to 2 provided by the composite structure in accordance with the present invention is an increase over that of polyethylene foam alone, and has been found sufficient to maintain tools in place in tool boxes when used as a liner therefor, reduce or eliminate slipping when used as a non-skid foam for, e.g., aircraft maintenance, and keep the composite structure in place on a packaged article when used as a protective packaging wrap. At the same time, the excellent cushioning characteristics of PE foam are retained, so that the tools and tool box, aircraft wing surface, and package articles are protected.

### BRIEF DESCRIPTION OF THE DRAWINGS

FIG. 1 is an elevational, cross-sectional view of a composite structure in accordance with the present invention; and

FIG. 2 is a schematic view of a preferred process for making the composite structure shown in FIG. 1.

### DETAILED DESCRIPTION OF THE INVENTION

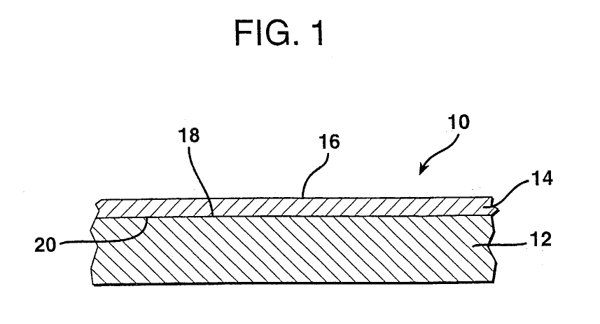

FIG. 1 illustrates a preferred composite structure 10 in accordance with the present invention, including a foam sheet 12 and a film 14 in adherence therewith.

The foam sheet 12 in accordance with the invention comprises a polyolefin, e.g., polyethylene, polypropylene, etc., preferably polyethylene homopolymer or copolymer including low density polyethylene, high density polyethylene, homogeneous ethylene/alpha-olefin copolymer, or heterogeneous ethylene/alpha-olefin copolymer. Most preferably, the polyolefin comprises low density polyethylene (LDPE) having a melt flow index ranging from about 4 to 30 g/cc.

The foam sheet may have any desired thickness to suit the particular intended application, preferably ranging, e.g., from about 1 to about 80 millimeters. The foam may have any desired density, ranging, e.g., from about 10 to about 150 kg/in³. The density preferably ranges from about 12-100 kg/M³ and, most preferably, from about 15 to 50 kg/m³. The foam sheet preferably has at least about 90% closed cells.

Any conventional chemical or physical blowing agents may be used. Preferably, the blowing agent is a physical blowing agent such as carbon dioxide, ethane, propane, n-butane, isobutane, pentane, hexane, butadiene, acetone, methylene chloride, any of the chlorofluorocarbons, hydrochlorofluorocarbons, or hydrofluorocarbons, as well as mixtures of the foregoing.

The blowing agent may be mixed with the polyolefin blend in any desired amount to achieve a desired degree of expansion in the resultant foam. Generally, the blowing agent may be added to the polyolefin blend in an amount ranging from about 0.5 to 80 parts by weight, based on 100 parts by weight of the polyolefin blend. More preferably, the blowing agent is present at an amount ranging from 1 to 30 and, most preferably, from 3 to 15 parts per 100 parts by weight of the polyolefin blend.

If desired or necessary, various additives may also be included with the polyolefin blend. For example, it may be desirable to include a nucleating agent (e.g., zinc oxide, zirconium oxide, silica, talc, etc.) and/or an aging modifier (e.g., a fatty acid ester, a fatty acid amide, a hydroxyl amide, etc.). Other additives that may be included if desired are pigments, colorants, fillers, antioxidants, flame retardants, stabilizers, fragrances, odor masking agents, and the like.

Foam in accordance with the present invention is preferably made by an extrusion process as is well known in the art. In such a process, the polyethylene or other polyolefin is added to an extruder, preferably in the form of resin pellets. Any conventional type of extruder may be used, e.g., single screw, double screw, and/or tandem extruders. In the extruder, the resin pellets are melted and mixed. A blowing agent is preferably added to the melted polyolefin via one or more injection ports in the extruder. Any additives that are used may be added to the melted polyolefin blend in the extruder and/or may be added with the resin pellets. The extruder pushes the entire melt mixture (melted polyolefin, blowing agent, and any additives) through a die at the end of the extruder and into a region of reduced temperature and pressure (relative to the temperature and pressure within the extruder). Typically, the region of reduced temperature and pressure is the ambient atmosphere. The sudden reduction in pressure causes the blowing agent to nucleate and expand into a plurality of cells that solidify upon cooling of the polymer mass (due to the reduction in temperature), thereby trapping the blowing agent within the cells.

Referring again to FIG. 1, film 14 includes an upper surface 16 and a lower surface 18, the lower surface 18 being adhered to a surface 20 of foam sheet 12. If desired, a second film 14 may be adhered to an opposing surface of the foam sheet such that both major surfaces of the foam sheet have a film 14 adhered thereto. Film 14 preferably has a thickness ranging from about 1 to about 20 mils; more preferably from about 2 to about 8 mils; and most preferably between about 3 and 6 mils.

In order to provide an increase in the COF of the foam sheet, film 14 may comprise an ethylene/styrene interpolymer (“ESI”), which has been found to provide a beneficial increase in COF of a PE foam sheet when such ESI material is included in a film that is coated on one or both surfaces of such foam sheet. The ESI preferably has a styrene content ranging from 20 to 80 percent by weight, a melt index ranging from 1 to 50, and a specific gravity ranging from 0.91 to 1.05 g/cc. A more preferred styrene content is 20 to 40 wt. %. Preferred ethylene-styrene interpolymers are manufactured by copolymerization of ethylene and styrene monomers using metallocene, i.e., single-site, constrained-geometry, catalysts. Suitable ESI resins are available from the Dow Chemical Company, as manufactured under their proprietary “Insite” technology. An example of a preferred ESI resin is set forth in the Examples below.

Surprisingly, it has been found that when ESI is formed into (or incorporated as a component of) film 14 and adhered to a polyolefin foam sheet 12 in accordance with the present invention, the resultant composite structure 10 beneficially has a COF ranging from about 0.5 to about 2.0. That is, the combined effect of film 14 in adherence with the foam sheet 12 has been found to produce a resultant COF ranging from about 0.5 to about 2.0, as measured at the upper surface 16 of film 14 in accordance with ASTM D 1894. Thus, the cushioning effect provided by the foam in combination with the highly elastomeric nature of the film adhered to the foam results in a COF ideally suited for tool box liners, non-skid foams, and packaging applications. A COF greater than 2 would result in a film/foam composite structure having excessive tackiness while a COF less than about 0.5 is generally an insufficient improvement over the COF of PE foam alone, which is about 0.4 or less.

A further advantage of ESI in film 14 is that it is receptive to printing inks, and therefore allows the composite structure 10 to have printed indicia displayed on upper surface 16.

When the present composite structure is to be used as a tool box liner, a non-skid surface for, e.g., aircraft maintenance, or a packaging material, the COF of the structure preferably ranges from about 0.5 to about 1.5 and, most preferably, from about 0.8 to about 1.5.

The inventor has found that excellent COF results may be achieved by blending a thermoplastic elastomer with ESI to form film 14. A suitable thermoplastic elastomer that may be blended with the ESI preferably comprises a copolymer or terpolymer including a styrenic component and a rubbery component, with the rubbery component having at least one carbon-carbon double bond and comprising at least about 70 wt. % of the thermoplastic elastomer. A preferred thermoplastic elastomer comprises a block copolymer or terpolymer, wherein the rubbery component is distributed in the copolymer or terpolymer between styrenic end-blocks. Preferred examples of such block copolymers or terpolymers that are useful in accordance with the present invention include the following: styrene-ethylene-butylene-styrene block copolymer (SEBS), styrene-butadiene-styrene block copolymer (SBS), and styrene-isoprene-styrene block copolymer (SIS).

As an alternative to block copolymers and terpolymers, random copolymers and terpolymers comprising styrene and a rubbery component may be employed, such as polybutadiene/styrene rubber.

It may be possible to employ other elastomers in film 14 such as, e.g., polybutadiene rubber, butyl rubber, polychloroprene rubber, acrylonitrile-butadiene rubber, vinylpyridine rubber, ethylene-propylene rubber, etc., provided that such elastomers can be processed into a film and applied to the surface of a polyolefin foam sheet, and will effectively increase the COF of the resultant composite structure. Thermoplastic elastomers comprising a styrenic component and a rubber component as described above have been found optimally suited to achieve the foregoing objectives in accordance with the present invention.

A preferred elastomer is SIS block copolymer, having styrene end blocks and a rubbery isoprene mid block, particularly an SIS having greater than 80 wt. % isoprene (i.e., the rubbery component).

When ESI is blended with a thermoplastic elastomer, the ESI preferably comprises 50-90 weight percent of such blend and the elastomer preferably comprises 10-50 weight percent of the blend, such weight percentages being based on the total amount of ESI and elastomer in the blend.

If desired, e.g., to reduce the cost and/or COF of the composite structure, a polyethylene homopolymer or copolymer may be blended with the ESI and thermoplastic elastomer. Suitable polyethylenes include low density polyethylene, high density polyethylene, homogeneous (i.e., metallocene-catalyzed) ethylene/alpha-olefin copolymer, or heterogeneous (i.e., Ziegler-Natta catalyzed) ethylene/alpha-olefin copolymer. Such blend may include 30-80 weight percent ESI, 10-30 weight percent elastomer, and 10-40 weight percent polyethylene (each of the foregoing weight percentages being based on the total amount of ethylene/styrene interpolymer, elastomer, and polyethylene in the blend).

In accordance with another aspect of the present invention, film 14 may comprise a homogeneous ethylene/alpha-olefin copolymer. As used herein and well understood in the art, a “homogeneous” ethylene/alpha-olefin copolymer refers to ethylene/alpha-olefin copolymerization reaction products of relatively narrow molecular weight distribution and relatively narrow composition distribution. Homogeneous ethylene/alpha-olefin copolymers are structurally different from heterogeneous ethylene/alpha-olefin copolymers, in that homogeneous ethylene/alpha-olefins exhibit a relatively even sequencing of comonomers within a chain, a mirroring of sequence distribution in all chains, and a similarity of length of all chains, i.e., a narrower molecular weight distribution. Furthermore, homogeneous ethylene/alpha-olefin copolymers are typically prepared using metallocene, or other single-site type catalysts, rather than using Ziegler Natta catalysts. Such single-site catalysts typically have only one type of catalytic site, which is believed to be the basis for the homogeneity of the polymers resulting from the polymerization. A homogeneous ethylene/alpha-olefin copolymer can, in general, be prepared by the copolymerization of ethylene and any one or more alpha-olefin. Preferably, the alpha-olefin is a C₃-C₂₀ alpha-monoolefin, more preferably, a C₄-C₁₂ alpha-monoolefin, still more preferably, a C₄-C₈ alpha-monoolefin. Still more preferably, the alpha-olefin comprises at least one member selected from the group consisting of 1-butene, 1-pentene, 1-hexene, and 1-octene.

Preferred homogeneous ethylene/alpha-olefins have a density in the range of 0.87-0.91 g/cc and a melt index ranging from about 2 to about 40.

When formed or incorporated into film 14, homogeneous ethylene/alpha-olefin copolymers have been found to provide composite structure 10 with a COF of greater than 1. The COF may be increased by blending a thermoplastic elastomer with the homogeneous ethylene/alpha-olefin copolymer. Such elastomer is preferably as described above, and may comprise 10-60 weight percent of the blend, with homogeneous ethylene/alpha-olefin copolymer comprising 40-90 weight percent (based on the total amount of homogeneous ethylene/alpha-olefin copolymer and elastomer in the blend).

In preferred applications, the composite structure 10 is in the form of a sheet suitable for disposal in a substantially flat configuration as shown in FIG. 1, with the film 14 facing upwards, such that objects can be placed on the film portion of the structure. Such objects include tools, when the composite structure is used as a tool box liner, or shoes when it is used as non-skid foam, e.g., for aircraft maintenance. As such, the coefficient of friction in accordance with the invention is sufficient to reduce the tendency for the objects to move in relation to the structure, as compared with polyolefin foam alone, i.e., without a film to improve the COF.

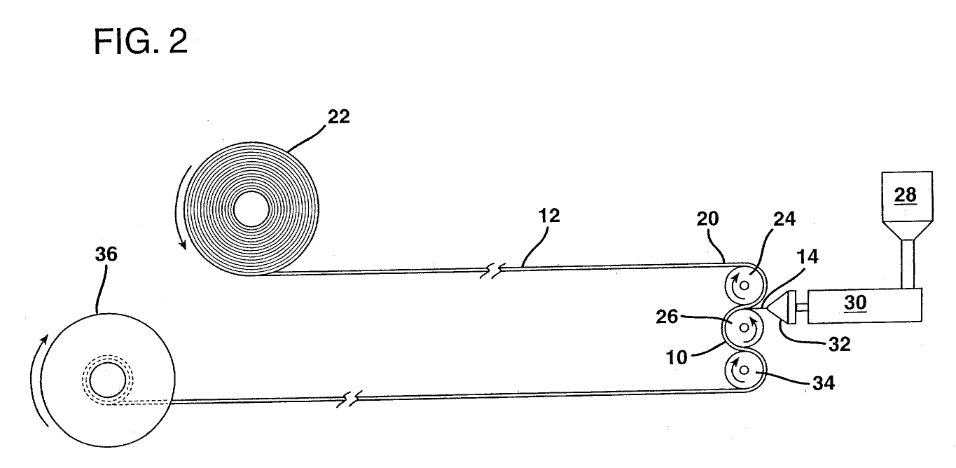

Having now described the composite structure in accordance with the invention, a preferred method for making the same will be discussed with reference to FIG. 2. Foam sheet 12 is unwound from a storage roll 22 and sent to nip roller 24. Simultaneously, film 14 is extruded onto surface 20 of foam sheet 12 between nip roller 24 and chill roller 26. This is a result of placing desired resin pellets of materials used to make film 14 (e.g., ESI, homogeneous ethylene/alpha-olefin copolymer, thermoplastic elastomer, etc.) into hopper 28, from which they enter extruder 30 wherein the pellets are mixed and melted. The resulting molten polymer blend is extruded into and through flat film die 32 and onto surface 20 of foam sheet 12 as shown. Chill roller 26 is maintained at a sufficiently low temperature, e.g., less than 80° F., such as between 50-80° F., to cause the extruded polymer blend to solidify into film 14 in adherence with foam sheet 12. In addition, nip roller 24 and chill roller 26 are urged against one another, e.g., by mechanical or pneumatic means, with sufficient pressure to facilitate the bonding of the film to the foam by squeezing the film and foam together as they pass between the two rollers. A third roller 34 may also be included to keep the resultant composite structure 10 in contact with chill roller 32 for a full half revolution about the chill roller, and to again apply pressure to the film/foam composite to facilitate bonding of the two materials. The finished composite structure 10 is then wound on storage roll 36.

The foregoing process is known as an extrusion coating process because the film is extruded in a molten state onto a previously formed and solidified foam sheet, whereon the film congeals and solidifies. Such a process is well known and further described, e.g., in U.S. Pat. No. 3,616,020. It is to be understood, however, that a method in accordance with the present invention is not limited to the illustrated extrusion coating process. Many alternatives are possible. For instance, instead of the ‘off-line’ extrusion coating process illustrated in FIG. 2, wherein a previously made foam sheet is taken from a storage roll, an ‘in-line’ process may be employed wherein the foam sheet can be extruded from a die and allowed to travel a sufficient distance to solidify before being coated with a film, without the intermediate steps of winding and unwinding the foam on and from a storage roll. As a further alternative, a coextrusion process may be used in which the film and foam are simultaneously extruded from separate dies and brought into contact with one another while both are still in a molten state. The foam and film may also be separately manufactured and then laminated together via any conventional or suitable means, including heat, pressure, adhesives, corona treatment, etc.

These and other aspects and advantages of the invention may be further understood by reference to the following examples, which are provided for illustrative purposes only and are not intended in any way to be limiting.

### EXAMPLES

In each of the following examples, foam sheets comprising LDPE having an average thickness of ⅛ inch, width of 48 inches, and density of 3 pounds/cubic foot (pcf) were formed of LDPE in a single-screw extruder using butane as a blowing agent.

In each of the examples that follow, Example 1 was a comparative sample having no film adhered to the foam sheet. Each of the other examples were composite structures in accordance with the invention having a film adhered to a surface of the foam. In each case, the film was adhered to the foam by the extrusion coating process described above and illustrated in FIG. 2. The resultant film in adherence with the foam sheets in each of the following examples had an average thickness ranging from about 4 to about 5 mils.

All ratios reported in the tables below are weight ratios unless otherwise specified.

Coefficient of Friction (COF) testing was performed on each sample in accordance with ASTM D 1894, except that an aluminum sled pulled at 12 inches/minute across the surface of the sample weighed 155 grams instead of the 200 gram weight as specified in the ASTM test. Each reported COF value is the average kinetic COF obtained from 5 separate measurements on each example.

In Examples 2-6, as summarized below in Table 1, film/foam composite structures were made by extrusion coating, onto the surface of a 3 pcf (48 kg/m3) LDPE foam sheet, a film comprising

100% ESI (Example 5)

blends of ESI and an elastomer (Examples 2-4)

a blend of ESI, elastomer, and LDPE (Example 6).

The ESI used was DE400.01 ethylene/styrene interpolymer obtained from Dow Chemical, USA, having a melt index of 9.6, a specific gravity of 0.938 g/cc, and a styrene content of 30 wt. %. The elastomer used in Examples 2-4 and 6 was Europrene SOL T 190 thermoplastic elastomer from EniChem Elastomers Americas, Inc., a styrene-isoprene-styrene (SIS) block copolymer having a 84 wt. % isoprene (rubbery) component and a 16 wt. % styrenic component. The LDPE used in the blend of Example 6 was Huntsman XO929 low density polyethylene with a MI of 3.3 and density of 0.919 g/cc.

In Examples 7-8, as summarized below in Table 1, film/foam composite structures were made by extrusion coating, onto the surface of a 3 pcf (48 kg/m3) LDPE foam sheet, a film comprising

100% metallocene-catalyzed ethylene/alpha-olefin copolymer (“m-EAO”) (Example 7)

a blend of m-EAO and elastomer (Example 8).

In Example 7, the m-EAO was Exact 4049 plastomer, a metallocene-catalyzed (homogeneous) ethylene/octene copolymer obtained from ExxonMobil Chemical, USA, having a melt index of 4.5 and a density of 0.873 g/cc. In Example 8, the m-EAO was Exact 4023 plastomer, a metallocene-catalyzed (homogeneous) ethylene/butene copolymer obtained from ExxonMobil Chemical, USA, having a melt index of 35 and a density of 0.882 g/cc. Also in Example 8, the elastomer used was Europrene SOL T 190 thermoplastic elastomer (described above).

The COF testing results are summarized below in Table 1:

TABLE 1

| | Coefficient | |
|---|---|---|
| Example | of Friction | Comments |
| 1. 3 pcf LDPE foam | 0.38 | Slippery surface |
| with no film | | |
| (comparative) | | |
| 2. 3 pcf LDPE foam + | 1.19 | Excellent tackiness |
| film [20/80 blend: | | |
| Europrene Sol T190 | | |
| SIS/DE400 ESI] | | |
| 3. 3 pcf LDPE foam + | 1.32 | Excellent tackiness |
| film [30/70 blend: | | |
| Europrene Sol T190 | | |
| SIS/DE400 ESI] | | |
| 4. 3 pcf LDPE foam + | 1.49 | Excellent tackiness |
| film [50/50 blend: | | |
| Europrene Sol T190 | | |
| SIS/DE400 ESI] | | |
| 5. 3 pcf LDPE foam + | 0.63 | Good tackiness |
| film [100% DE400 ESI] | | |
| 6. 3 pcf LDPE foam + | 0.50 | Light tackiness |
| film [20/40/40 blend: | | |
| Europrene Sol T190 | | |
| SIS/DE400 ESI/LDPE] | | |
| 7. 3 pcf LDPE foam + | 1.15 | Excellent tackiness |
| film [100% m-EAO | | |
| (Exact 4049 | | |
| plastomer)] | | |
| 8. 3 pcf LDPE foam + | 1.36 | Excellent tackiness |
| film [50/50 blend: | | |
| Europrene Sol T190 | | |
| SIS/m-EAO (Exact | | |
| 4023 plastomer)] | | |

While the invention has been described with reference to illustrative examples, those skilled in the art will understand that various modifications may be made to the invention as described without departing from the scope of the claims which follow.

What is claimed is:

1. A composite structure comprising:
a. a foam sheet comprising polyolefin; and
b. a film having an upper surface and a lower surface in adherence with a surface of said foam sheet, said film comprising at least one member selected from
(1) ethylene/styrene interpolymer,
(2) a blend of ethylene/styrene interpolymer and a thermoplastic elastomer,
(3) a blend of ethylene/styrene interpolymer, a thermoplastic elastomer, and polyethylene homopolymer or copolymer,
(4) homogeneous ethylene/alpha-olefin copolymer having a density in the range of 0.87-0.91 g/cc, or
(5) a blend of said homogeneous ethylene/alpha-olefin copolymer and a thermoplastic elastomer,
whereby, said film in adherence with said foam sheet results in a coefficient of friction ranging from about 0.5 to about 2.0 as measured at said upper surface of said film.

2. The composite structure of claim 1, wherein said blend of ethylene/styrene interpolymer and thermoplastic elastomer comprises 50-90 weight percent ethylene/styrene interpolymer and 10-50 weight percent elastomer, said weight percentages based on the total amount of ethylene/styrene interpolymer and elastomer in said blend.

3. The composite structure of claim 1, wherein said blend of said ethylene/styrene interpolymer, thermoplastic elastomer, and polyethylene homopolymer or copolymer comprises 30-80 weight percent ethylene/styrene interpolymer, 10-30 weight percent elastomer, and 10-40 weight percent polyethylene, said weight percentages based on the total amount of ethylene/styrene interpolymer, elastomer, and polyethylene in said blend.

4. The composite structure of claim 1, wherein said blend of said homogeneous ethylene/alpha-olefin copolymer and said elastomer comprises 40-90 weight percent ethylene/alpha-olefin copolymer and 10-60 weight percent elastomer, said weight percentages based on the total amount of ethylene/alpha-olefin copolymer and elastomer in said blend.

5. The composite structure of claim 1, wherein said ethylene/styrene interpolymer comprises between 20 to 80 weight percent styrene units.

6. The composite structure of claim 1, wherein said thermoplastic elastomer comprises a copolymer or terpolymer comprising a styrenic component and a rubbery component, said rubbery component having at least one carbon-carbon double bond and comprising at least about 70 wt. % of said thermoplastic elastomer.

7. The composite structure of claim 6, wherein said thermoplastic elastomer comprises a block copolymer or terpolymer and said rubbery component is distributed therein between styrenic end-blocks.

8. The composite structure of claim 7, wherein said thermoplastic elastomer comprises at least one material selected from styrene-ethylene-butylene-styrene block copolymer, styrene-butadiene-styrene block copolymer, or styrene-isoprene-styrene block copolymer.

9. The composite structure of claim 1, wherein said polyethylene homopolymer or copolymer comprises at least one material selected from low density polyethylene, high density polyethylene, homogeneous ethylene/alpha-olefin copolymer, or heterogeneous ethylene/alpha-olefin copolymer.

10. The composite structure of claim 1, wherein said coefficient of friction ranges from about 0.5 to about 1.5.

11. A method for making a composite structure, comprising:
a. providing a foam sheet comprising polyolefin; and
b. adhering a film having an upper surface and a lower surface to a surface of said foam sheet, said lower surface of said film being in adherence with said foam sheet, said film comprising at least one member selected from
(1) ethylene/styrene interpolymer,
(2) a blend of ethylene/styrene interpolymer and a thermoplastic elastomer,
(3) a blend of ethylene/styrene interpolymer, a thermoplastic elastomer, and polyethylene homopolymer or copolymer,
(4) homogeneous ethylene/alpha-olefin copolymer having a density in the range of 0.87-0.91 g/cc, or
(5) a blend of said ethylene/alpha-olefin copolymer and a thermoplastic elastomer,
whereby, said film in adherence with said foam sheet results in a coefficient of friction ranging from about 0.5 to about 2.0 as measured at said upper surface of said film.

12. The method of claim 11, wherein said blend of ethylene/styrene interpolymer and thermoplastic elastomer comprises 50-90 weight percent ethylene/styrene interpolymer and 10-50 weight percent elastomer, said weight percentages based on the total amount of ethylene/styrene interpolymer and elastomer in said blend.

13. The method of claim 11, wherein said blend of said ethylene/styrene interpolymer, thermoplastic elastomer, and polyethylene homopolymer or copolymer comprises 60-80 weight percent ethylene/styrene interpolymer, 10-20 weight percent elastomer, and 10-20 weight percent polyethylene, said weight percentages based on the total amount of ethylene/styrene interpolymer, elastomer, and polyethylene in said blend.

14. The method of claim 11, wherein said blend of said ethylene/alpha-olefin copolymer and said elastomer comprises 60-90 weight percent ethylene/alpha-olefin copolymer and 10-40 weight percent elastomer, said weight percentages based on the total amount of ethylene/alpha-olefin copolymer and elastomer in said blend.

15. The method of claim 11, wherein said ethylene/styrene interpolymer comprises between 20 to 80 weight percent styrene units.

16. The method of claim 11, wherein said thermoplastic elastomer comprises a copolymer or terpolymer comprising a styrenic component and a rubbery component, said rubbery component having at least one carbon-carbon double bond and comprising at least about 70 wt. % of said thermoplastic elastomer.

17. The method of claim 16, wherein said thermoplastic elastomer comprises a block copolymer or terpolymer and said rubbery component is distributed therein between styrenic end-blocks.

18. The method of claim 17, wherein said thermoplastic elastomer comprises at least one material selected from styrene-ethylene-butylene-styrene block copolymer, styrene-butadiene-styrene block copolymer, or styrene-isoprene-styrene block copolymer.

19. The method of claim 11, wherein said polyethylene homopolymer or copolymer comprises at least one material selected from low density polyethylene, high density polyethylene, homogeneous ethylene/alpha-olefin copolymer, or heterogeneous ethylene/alpha-olefin copolymer.

20. The method of claim 11, wherein said coefficient of friction ranges from about 0.5 to about 1.5.

21. The method of claim 11, wherein said film is extrusion coated onto said surface of said foam sheet to form said composite structure, said composite structure then being passed between a pair of rollers, at least one of said rollers being maintained at a temperature of less than 80° F.
